(19) United States
(12) Patent Application Publication
(10) Pub. No.: US 2026/0329630 A1
(43) Pub. Date: Oct. 22, 2026

(54) ELECTRONIC FRAMEWORK FOR PERSONALIZED PLANNING ASSISTANCE

(71) Applicant: GM GLOBAL TECHNOLOGY OPERATIONS LLC, Detroit, MI (US)

(72) Inventors: Venkata Naga Siva Vikas Vemuri, Farmington Hills, MI (US); Azin Neishaboori, Plymouth, MI (US); Paolo Giusto, Brentwood, CA (US); Arun Adiththan, Sterling Heights, MI (US); Prakash M. Peranandam, Rochester Hills, MI (US)

(73) Assignee: GM GLOBAL TECHNOLOGY OPERATIONS LLC, Detroit, MI (US)

(21) Appl. No.: 19/184,356

(22) Filed: Apr. 21, 2025

(51) Int. Cl. G06F 9/48; G06F 9/54; H04L 9/40

(52) U.S. Cl. CPC G06F 9/4881; G06F 9/547; H04L 63/08; H04L 63/105

(57) ABSTRACT

An electronic framework for enabling personalized assistance to a user of a vehicle includes a controller and a central platform is in communication with the controller. The central platform is located remotely relative to the vehicle. Multiple local platforms with respective resources are in communication with the central platform. The controller is adapted to request the central platform for interaction with at least one of the multiple local platforms. The central platform is adapted to verify respective credentials of the multiple local platforms, assess availability of the respective resources and generate a resource access schedule. The central platform is adapted to transmit the resource access schedule to the controller and the multiple local platforms. The central platform and the multiple local platforms include a common set of application programming interfaces (APIs) enabling resource reservation and resource cancellation for the respective resources in the resource access schedule.

### INTRODUCTION

The present disclosure relates generally to an electronic framework, also referred to as a protocol or architecture, for connected ecosystems, enabling personalized assistance to a user of a vehicle. The number and variety of smart devices and connected systems has grown tremendously over recent times. Various projections suggest continued rapid growth as technology becomes more affordable and energy efficient. As these connected systems grow in complexity and capability, it becomes increasingly challenging to create a framework that enables smooth operation and enables effective communication between the various entities.

### SUMMARY

Disclosed herein is an electronic framework for enabling personalized assistance to a user of a vehicle. The electronic framework includes a controller installed in the vehicle, the controller having a processor and tangible, non-transitory memory on which instructions are recorded. A central platform is in communication with the controller. The central platform is located remotely relative to the vehicle. Multiple local platforms are in communication with the central platform, with the multiple local platforms having respective resources.

The controller is adapted to request the central platform for interaction with at least one of the multiple local platforms. The central platform is adapted to verify respective credentials of the multiple local platforms, assess availability of the respective resources and generate a resource access schedule based on availability of the respective resources. The central platform is adapted to transmit the resource access schedule to the controller and the multiple local platforms. The central platform and the multiple local platforms include a common set of application programming interfaces (APIs) enabling resource reservation and resource cancellation for the respective resources in the resource access schedule.

The central platform may be adapted to define the common set of APIs and conduct a negotiation regarding the resource access schedule with the multiple local platforms based on the common set of APIs. The resource access schedule is updated based on the negotiation. The central platform may be adapted to execute an authentication module upon receiving a registration request from at least one of the multiple local platforms, and designate a respective participation level for the multiple local platforms. The respective participation levels include a first tier access level and a second tier access level. The central platform may be adapted to provide a status update of the resource access schedule to the controller upon user demand.

In some embodiments, the central platform is adapted to execute a scheduling module, including queueing the respective resources based in part on a nature of the respective resources and respective locations on a user route. Executing the scheduling module includes running a priority check when a plurality of the respective resources are requested by the controller.

The multiple local platforms may include a first local platform and a second local platform. In some embodiments, the central platform is adapted to transmit a participation request from the first local platform to the second local platform when the first local platform submits the participation request to the central platform for engaging with the second local platform. The central platform is adapted to transmit an access granted message and one or more negotiated limitations to the first local platform when the participation request is successful. The central platform is adapted to submit an alternative resource recommendation to the first local platform when the participation request is not successful. The electronic framework may include a mobile application operable by the user and adapted to interface with the controller. The mobile application may be hosted by an infotainment unit in the vehicle.

The central platform may be adapted to communicate with the multiple local platforms via a publish-subscribe messaging protocol, such as Message Queue Telemetry Transport (MQTT). The multiple local platforms may include a transportation hub, a lodging facility, and a food service establishment. The multiple local platforms may include a home system, a paid parking facility and another vehicle. The multiple local platforms may include a charging station, a roadside unit, and a tolling unit.

Disclosed herein is a method for establishing an electronic framework for providing personalized assistance to a user in a vehicle having a controller with a processor and tangible, non-transitory memory on which instructions are recorded. The method includes establishing bi-directional communication between a central platform and the controller. The central platform is located remotely relative to the vehicle, and is communicatively coupled to multiple local platforms having respective resources. The method includes adapting the controller to request the central platform for interaction with at least one of the multiple local platforms. The method includes verifying respective credentials of the multiple local platforms, assessing availability of the respective resources and generating a resource access schedule based on availability of the respective resources, via the central platform. The resource access schedule is transmitted to the controller and the multiple local platforms, via the central platform. The method includes incorporating a common set of application programming interfaces (APIs) in the central platform and the multiple local platforms to enable resource reservation and resource cancellation for the respective resources in the resource access schedule.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic fragmentary diagram of an electronic framework for providing personalized assistance to a user in a vehicle, the framework including a central platform;

FIG. 2 is a schematic diagram of an example architecture employable by the framework of FIG. 1;

FIG. 3 is a flowchart for an example authentication module executable by the central platform of FIG. 1;

FIG. 4 is a flowchart for an example operational module executable by the central platform of FIG. 1;

FIG. 5 is a flowchart for an example scheduling module executable by the central platform of FIG. 1; and

FIG. 6 is a flowchart for an example request mechanism employable by the framework of FIG. 1.

Representative embodiments of this disclosure are shown by way of non-limiting example in the drawings and are described in additional detail below. It should be understood, however, that the novel aspects of this disclosure are not limited to the particular forms illustrated in the above-enumerated drawings. Rather, the disclosure is to cover modifications, equivalents, combinations, sub-combinations, permutations, groupings, and alternatives falling within the scope of this disclosure as encompassed, for instance, by the appended claims.

### DETAILED DESCRIPTION

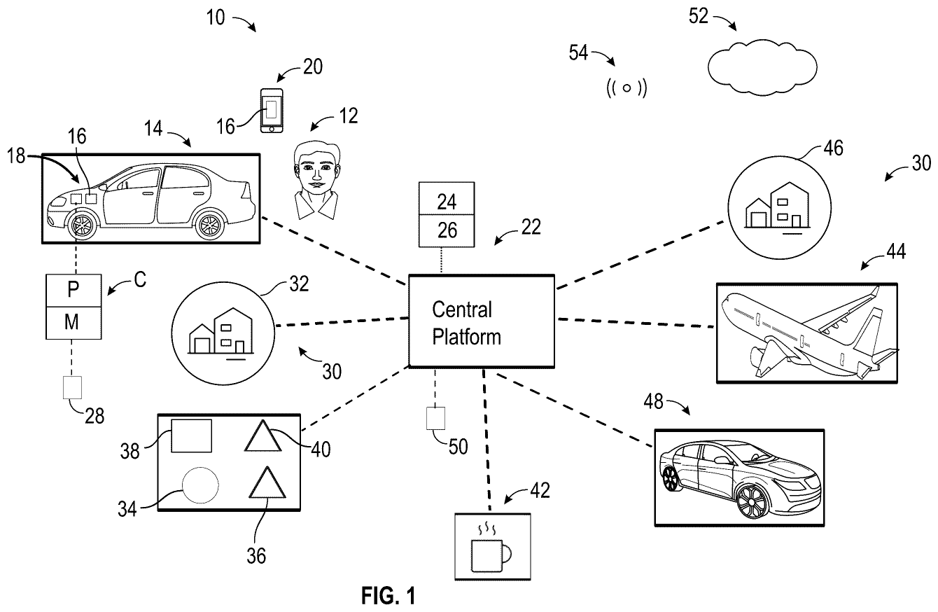

Referring to the drawings, wherein like reference numbers refer to like components, FIG. 1 schematically illustrates an electronic framework 10, also referred to as a protocol or architecture, for providing personalized assistance to a user 12 of a vehicle 14. The user 12 may be a driver or a passenger of the vehicle 14. The vehicle 14 may include, but is not limited to, a passenger vehicle, sport utility vehicle, light truck, heavy duty vehicle, minivan, bus, transit vehicle, bicycle, moving robot, farm implement (e.g., tractor), sports-related equipment (e.g., golf cart), boat, plane, train or another moving platform. The vehicle 14 may be a purely electric vehicle, a hybrid/partially electric vehicle, or have an internal combustion engine. The vehicle 14 may be an autonomous vehicle or a partially autonomous vehicle. It is to be understood that the vehicle 14 may take many different forms and have additional components.

The electronic framework 10 may be accessed through a request from the user 12, for example, through a mobile application 16, which may be hosted or executed by the infotainment unit 18 of the vehicle 14. The infotainment unit 18 may include a touchscreen or other IO device and may be incorporated in the dashboard, overhead visor (not shown), or other suitable location in the vehicle 14. The mobile application 16 may be hosted or executed on a smart device 20 (e.g., cell phone, tablet) of the user 12.

The electronic framework 10 provides intelligent planning, sequencing and routing capabilities by seamlessly connecting and collecting information from heterogenous IoT ecosystems, thus creating a personalized and optimized experience for the user 12 of the vehicle 14. Referring to FIG. 1, the vehicle 14 includes a controller C with at least one processor P and at least one memory M (or non-transitory, tangible computer readable storage medium). The memory M can store controller-executable instruction sets, and the processor P can execute the controller-executable instruction sets stored in the memory M.

Referring to FIG. 1, the electronic framework 10 provides a functional architecture for an application-level platform, with a central platform 22 and multiple local platforms 30 having respective resources/services. The central platform 22 implements protocols for applications in participating ecosystems to reserve, schedule, negotiate, and manage resources. The multiple local platforms 30 may be standalone or isolated eco-systems.

Referring to FIG. 1, the central platform 22 includes at least one processor 24 and at least one memory 26 (or non-transitory, tangible computer readable storage medium). Referring to FIG. 1, the vehicle 14 may include a connectivity module 28 adapted to transmit and receive information from the central platform 22 via wireless communication. The central platform 22 operates as a back office, managing the overall process. The central platform 22 may include one or more servers hosted on the Internet to store, manage, and process data. The central platform 22 may be manned electronically and/or by an administrator having access to an electronic device such as a desktop computer, laptop, tablet, cell phone or wearable device. The central platform 22 may be a private or public entity maintained by an organization.

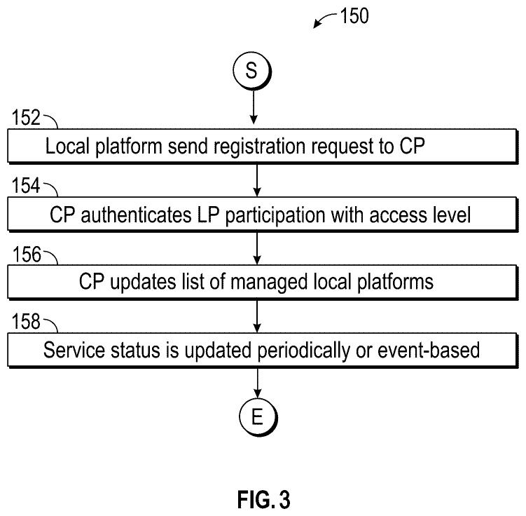

The central platform 22 is adapted to selectively execute one or more modules, including an authentication module 150, an operational module 200, and a scheduling module 300, which are described below with respect to FIGS. 3-5, respectively. Each of the local platforms 30 includes one or more connected devices or IoT devices. As understood by those skilled in the art, the internet of things (IoT) is a network of devices that may communicate with each other and with the cloud using the internet. For example, the connected device in a home ecosystem may include a garage door, wall mount charger, a front door, and a lighting system. The connected device in a smart city may include a parking spot. The vehicle 14 may be considered as an IoT device and/or IoT ecosystem. The electronic framework 10 may apply to other IoT devices and to a user 12 at home.

Examples of local platforms 30 are shown in FIG. 1. It is understood that the example shown here are non-limiting examples and other types of systems may be included. The local platforms 30 may include a smart home system 32, a paid parking facility 34 (e.g., commercial garage), a charging station 36, a roadside unit 38, and a tolling unit 40 (for collecting road tolls). The local platforms 30 may include a food service establishment 42 (e.g., restaurant or café), a transportation hub 44 (e.g., airport, a railway station, bus station etc.), and a lodging facility 46 (e.g., hotel, motel, vacation rental marketplace etc.) The local platforms 30 may include other vehicles 48. The controller C and/or central platform 22 may download and store additional information, such as associated user profiles for the user 12 from a cloud database 52.

As described below, the controller C is adapted to request the central platform 22 for interaction with at least one of the multiple local platforms 30. The central platform 22 is adapted to verify the respective credentials of the multiple local platforms 30, assess availability of the respective resources and generate a resource access schedule based on availability of the respective resources. The central platform transmits the resource access schedule to the controller C and the multiple local platforms.

The electronic framework 10 enables an IoT ecosystem to seamlessly access resources from heterogenous ecosystems on request or periodically. The central platform 22 and the local platforms 30 include a common set of application programming interfaces (APIs) enabling resource reservation and resource cancellation for the respective resources in the resource access schedule. An API (application programming interface) is a set of rules and protocols that allows different software applications to communicate and interact with each other, enabling them to exchange data, features, and functionality. The central platform 22 defines and controls the operation of the APIs, while the local platforms 30 implement and utilize the APIs. The local platforms 30 may publicize the available APIs to the central platform 22.

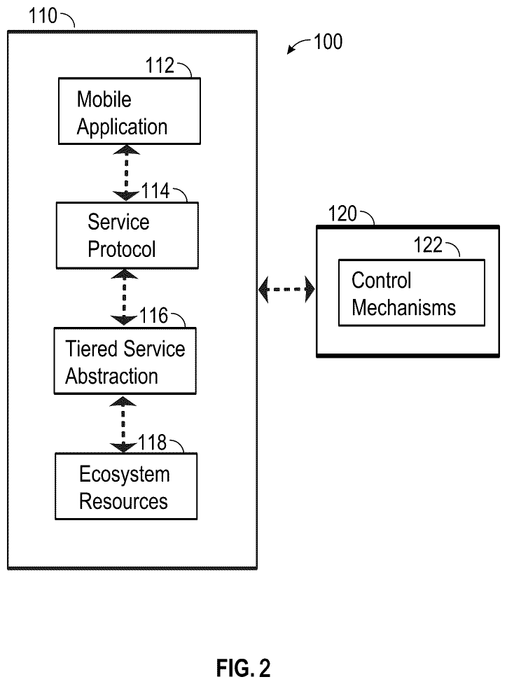

Referring now to FIG. 2, an example architecture 100 employable by the electronic framework 10 is shown. Here the components of local (IoT) ecosystems 110 interact amongst one another and with a central platform 120. The local (IoT) ecosystems 110 include a mobile application 112 that engages with a service protocol layer 114, which incorporates APIs, basic services and protocols for various requests. The service protocol layer 114 further engages with a tiered service abstraction layer 116 and an ecosystem resources layer 118. Referring to FIG. 2, the central platform 120 incorporates various operational control mechanism 122, such as authentication, trust establishment, definition of APIs and access requirements. The central platform 22 implements protocols to integrate or enroll trusted devices (e.g., smart device 20, vehicle 14) to deploy the application services. The central platform 22 is adapted to process user requests, analyze device status, facilitate information exchange, status prediction and recommending options.

Referring now to FIG. 3, a flowchart for an example authentication module 150 is shown. Module 150 may be embodied as computer-readable code or instructions stored on and at least partially executable by the central platform 22. Module 150 need not be applied in the specific order recited herein. Furthermore, it is to be understood that some blocks or steps may be eliminated.

Beginning at block 152 of FIG. 2, the central platform 22 (“CP”) receives a registration request from at least one of the local platforms 30. The central platform 22 executes an API negotiation and registration procedure whereby the resources provided by the local platforms 30 are catalogued and registered. The API negotiation takes note of limitations and constraints associated with each of the resources provided (e.g., restricted hours). Proceeding to block 154, the central platform 22 designates a respective participation level for each the multiple local platforms 30. The respective participation level may include several levels, such as a first tier access level (greater services offered) and a second tier access level (fewer services offered). The participant level may be based on the results of the API negotiation.

Advancing to block 156, the list of managed local platforms 30 at the central platform 22 is updated. Per block 158, the central platform 22 may be adapted to provide a resource status update to the controller C upon demand and/or periodically. Module 150 is then ended.

The central platform 22 may employ a machine learning module 50 to perform some of the functions noted above, such as designating the respective participation level based on historical data. In some embodiments, the machine learning module 50 may include a neural network trained using training datasets retrieved by the central platform 22. The training process may occur in a closed loop or iterative fashion, with the neural network being trained until a certain criteria is met, i.e., until the discrepancy between the network outcome and ground truth reaches a point below a certain threshold. As a predefined loss function related to the training dataset is minimized, the neural network reaches convergence. The convergence signals the completion of the training.

The electronic framework 10 may be configured to be “adaptive” and updated continuously or periodically after the collection of additional training data for the machine learning module 50. It is to be understood that the electronic framework 10 is not limited to a specific neural network methodology.

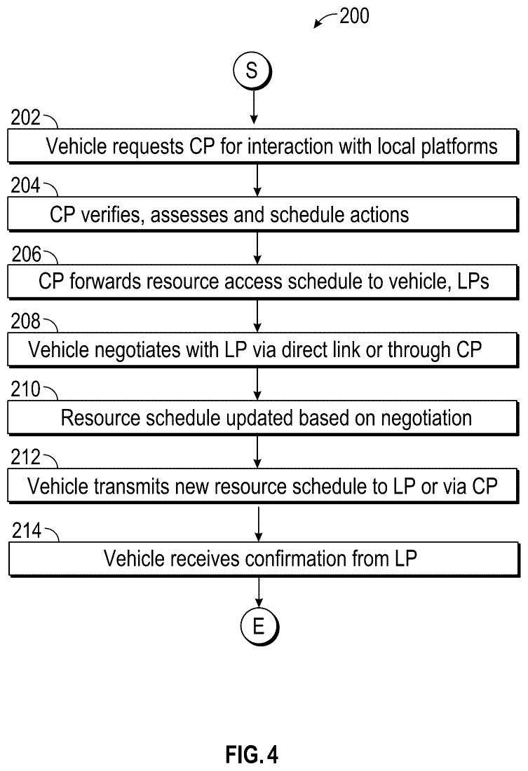

Referring now to FIG. 4, a flowchart for an example operational module 200 is shown. Module 200 may be embodied as computer-readable code or instructions stored on and at least partially executable by the central platform 22. Module 200 need not be applied in the specific order recited herein. Furthermore, it is to be understood that some blocks or steps may be eliminated.

Beginning at block 202, the controller C is adapted to transmit a request to the central platform 22 for interaction with at least one of the local platforms 30. Proceeding to block 204, the central platform 22 is adapted to verify respective credentials of the multiple local platforms 30, assess availability of the respective resources and generate a resource access schedule based on availability of the respective resources.

Advancing to block 206, the central platform 22 is adapted to transmit the resource access schedule to the controller C and the local platforms 30. Proceeding to block 208, the controller C is adapted to negotiate the respective resources (e.g., availability time and amount, cost per unit etc.) with the local platforms 30 via a direct link or through the central platform 22. Per block 210, the resource access schedule is updated based on the terms of the negotiation.

Advancing to block 212, controller C is adapted to transmit the updated resource access schedule to the local platforms 30 and the central platform 22. The controller C may reserve and/or cancel the resources in the resource access schedule through the central platform 22. Proceeding to block 214, the controller C is adapted to solicit confirmation from the local platforms 30 for the updated resource access schedule, i.e., verifying accuracy of the updated resource access schedule. The local platforms 30 may provide resource status change feedback to the central platform 22. The controller C may solicit confirmation from the local platforms 30 for resource reservations and/or resource cancellations. Module 200 is then ended.

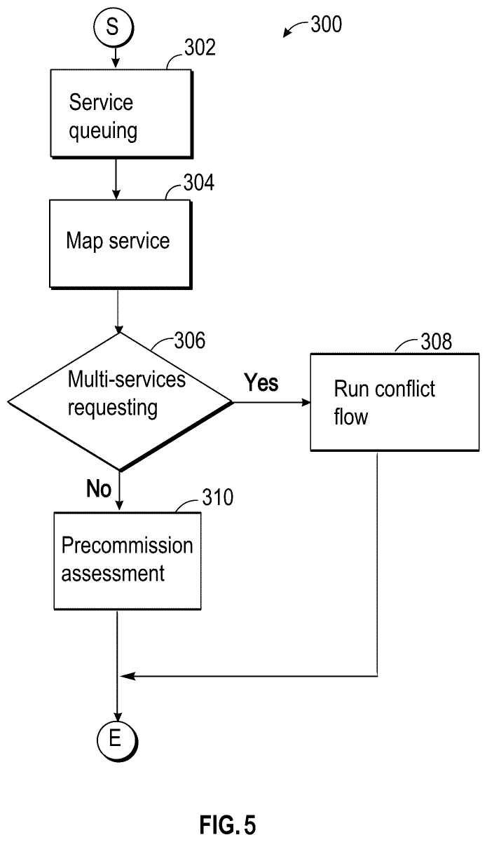

Referring now to FIG. 5, a flowchart for an example scheduling module 300 is shown. Module 300 may be embodied as computer-readable code or instructions stored on and at least partially executable by the central platform 22. Module 300 need not be applied in the specific order recited herein. Furthermore, it is to be understood that some blocks or steps may be eliminated.

Beginning at block 302, the central platform 22 is adapted to queue the respective resources or services (needed by the user 12) based in part on a nature of the services and positions on a route undertaken by the user 12. Proceeding to block 304, the central platform 22 is adapted to map the services to the respective resources offered by the local platforms 30. Advancing to block 306, the central platform 22 is adapted to determine if multiple services are being requested by the controller C. If so (block 306=YES), the module 300 proceeds to block 308 to run a priority conflict flow to see which service is a greater priority and if a conflict exists. If not (block 306=NO), the module 300 proceeds to block 310 to perform a commission assessment. Module 300 is then ended.

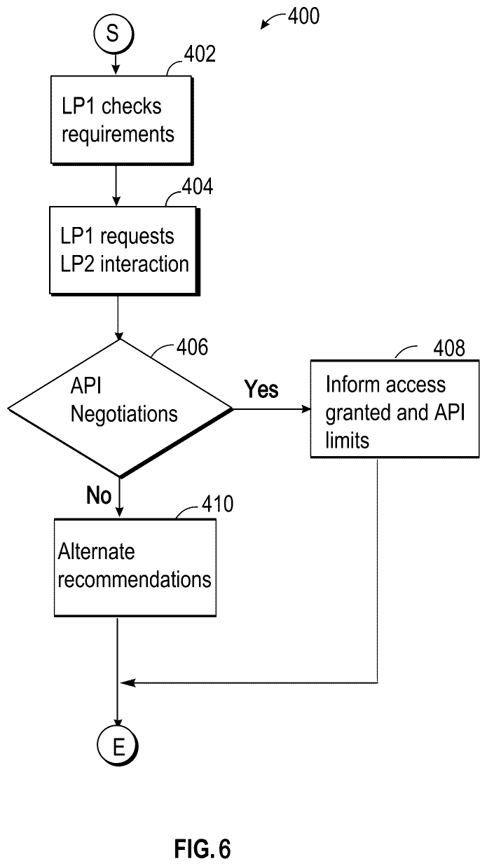

Referring now to FIG. 6, a flowchart for an example request mechanism 400 employable by the local platforms 30. Module 400 may be embodied as computer-readable code or instructions stored on and at least partially executable by the local platforms 30. Module 400 need not be applied in the specific order recited herein. Furthermore, it is to be understood that some blocks or steps may be eliminated.

Here the local platforms 30 include a first local platform (LP1) and a second local platform (LP2). Beginning at block 402, the first local platform checks the requirements for engaging with the second local platform, through data provided by the central platform 22. Proceeding to block 404, the first local platform submits a participation request to the central platform 22 for engaging with the second local platform. The central platform 22 is adapted to transmit the participation request to the second local platform.

Advancing to block 406, a registration procedure and negotiation is conducted between the second local platform and the central platform 22. The common set of application programming interfaces (APIs) allows for a negotiation between the second local platform and the central platform 22 on the terms of the engagement. If the negotiations are successful (block 406=YES), the module 400 proceeds to block 408 to inform the first local platform that access was granted and provides notification of conditions of the engagement (e.g., cost, timing, tier access level etc.). If the negotiations are not successful (block 406=NO), the module 400 proceeds to block 410, where the central platform 22 submits alternate resource recommendations to the first local platform.

The electronic framework 10 may employ subscription-tiered participation or access control for the local platforms 30. In some embodiments, the central platform 22 may communicate with the local platforms 30 and the controller C in accordance with a publish-subscribe messaging protocol. The publish-subscribe messaging protocol may be Message Queue Telemetry Transport (MQTT) or other mechanisms. The term “MQTT” includes variations and updates of MQTT. MQTT is a bi-directional communication protocol that allows the client devices and server application to become decoupled. The publish-subscribe messaging protocol may use an encryption model with certificate, username and password protected connections.

Additionally, the electronic framework 10 may assist in extraction of user requirements from its own connected devices, personal details, historical data, and profile information. The controller C may be adapted to transmit situational data to the central platform 22, including at least one of vehicle location data, vehicle status data, user preference data, and usage history data. The central platform 22 is adapted to analyze the situational data to determine one or more service recommendations for the user 12 from the multiple local platforms 30. The central platform 22 and/or controller C is adapted to build constraints to identify information pertaining to other ecosystems to present an optimal route, optimize travel cost, and a predefined user experience. The controller C is adapted to receive service recommendations from the central platform 22. Referring to FIG. 1, the mobile application 16 may be used to solicit user input on the resource recommendations. In some embodiments, the electronic framework 10 is accessible by a respective controller C in each individual vehicle. In a fleet, the electronic framework 10 may be accessible by a controller in a master vehicle.

In summary, the electronic framework 10 makes it efficient for different local platforms 30 to be accessed by a vehicle 14 and provides conflict resolution management for resources between requestors and suppliers. The framework 10 offers APIs and services for authentication, information requests, reservations, conflict resolution/and future availability prediction for requested resources, both locally and centrally.

Referring to FIG. 1, the various components of the electronic framework 10 may communicate via a wireless network 54, which may be a short-range network or a long-range network. The wireless network 54 may be a serial communication bus in the form of a local area network. The local area network may include, but is not limited to, a Command unit Area Network (MAY), a Command unit Area Network with Flexible Data Rate (MAY-FD), Ethernet, Bluetooth, WIFI and other forms of data. The wireless network 54 may be a Wireless Local Area Network (LAN) which links multiple devices using a wireless distribution method, a Wireless Metropolitan Area Network (MAN) which connects several wireless LANs or a Wireless Wide Area Network (WAN) which covers large areas such as neighboring towns and cities. Other types of network technologies or carrier systems available to those skilled in the art may be employed.

As used herein, the terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine.

The controller C of FIG. 1 includes a computer-readable medium (also referred to as a processor-readable medium), including a non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which may constitute a main memory. Such instructions may be transmitted by one or more transmission media, including coaxial cables, copper wire and fiber optics, including the wires that comprise a system bus coupled to a processor of a computer. Some forms of computer-readable media include, for example, a floppy disk, a flexible disk, hard disk, magnetic tape, other magnetic medium, a CD-ROM, DVD, other optical medium, a physical medium with patterns of holes, a RAM, a PROM, an EPROM, a FLASH-EEPROM, other memory chip or cartridge, or other medium from which a computer can read.

Look-up tables, databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store may be included within a computing device employing a computer operating system such as one of those mentioned above and may be accessed via a network in one or more of a variety of manners. A file system may be accessible from a computer operating system and may include files stored in various formats. An RDBMS may employ the Structured Query Language (SQL) in addition to a language for creating, storing, editing, and executing stored procedures, such as the PL/SQL language mentioned above.

The flowcharts illustrate an architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by specific purpose hardware-based systems that perform the specified functions or acts, or combinations of specific purpose hardware and computer instructions. These computer program instructions may also be stored in a computer-readable medium that can direct a controller or other programmable data processing apparatus to function in a particular manner, such that the instructions stored in the computer-readable medium produce an article of manufacture including instructions to implement the function/act specified in the flowchart and/or block diagram blocks.

The numerical values of parameters (e.g., of quantities or conditions) in this specification, including the appended claims, are to be understood as being modified in each respective instance by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of each value and further divided ranges within the entire range. Each value within a range and the endpoints of a range are hereby disclosed as separate embodiments.

The detailed description and the drawings or FIGS. are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. An electronic framework for enabling personalized assistance to a user of a vehicle, the electronic framework comprising:
a controller installed in the vehicle, the controller having a processor and tangible, non-transitory memory on which instructions are recorded;
a central platform in communication with the controller, the central platform being located remotely relative to the vehicle;
multiple local platforms in communication with the central platform, the multiple local platforms having respective resources;
wherein the controller is adapted to request the central platform for interaction with at least one of the multiple local platforms;
wherein the central platform is adapted to verify respective credentials of the multiple local platforms, assess availability of the respective resources and generate a resource access schedule based on availability of the respective resources;
wherein the central platform is adapted to transmit the resource access schedule to the controller and the multiple local platforms; and
wherein the central platform and the multiple local platforms include a common set of application programming interfaces (APIs) enabling resource reservation and resource cancellation for the respective resources in the resource access schedule.

2. The electronic framework of claim 1, wherein the central platform is adapted to define the common set of APIs and conduct a negotiation regarding the resource access schedule with the multiple local platforms based on the common set of APIs, the resource access schedule being updated based on the negotiation.

3. The electronic framework of claim 1, wherein the central platform is adapted to:
execute an authentication module upon receiving a registration request from at least one of the multiple local platforms; and
designate a respective participation level for the multiple local platforms, the respective participation level including first tier access level and a second tier access level.

4. The electronic framework of claim 1, wherein the central platform is adapted to provide a status update of the resource access schedule to the controller upon user demand.

5. The electronic framework of claim 1, wherein the central platform is adapted to execute a scheduling module, including queueing the respective resources based in part on a nature of the respective resources and respective locations on a user route.

6. The electronic framework of claim 5, wherein executing the scheduling module includes running a priority check when a plurality of the respective resources are requested by the controller.

7. The electronic framework of claim 1, wherein:
the multiple local platforms include a first local platform and a second local platform; and
the central platform is adapted to transmit a participation request from the first local platform to the second local platform when the first local platform submits the participation request to the central platform for engaging with the second local platform.

8. The electronic framework of claim 7, wherein:
the central platform is adapted to transmit an access granted message and one or more negotiated limitations to the first local platform when the participation request is successful; and
the central platform is adapted to submit an alternative resource recommendation to the first local platform when the participation request is not successful.

9. The electronic framework of claim 1, further comprising:
a mobile application operable by the user and adapted to interface with the controller; and
wherein the vehicle includes an infotainment unit, the mobile application being hosted by the infotainment unit.

10. The electronic framework of claim 1, wherein the central platform is adapted to communicate with the multiple local platforms via a publish-subscribe messaging protocol, including Message Queue Telemetry Transport (MQTT).

11. The electronic framework of claim 1, wherein the multiple local platforms include a transportation hub, a lodging facility, and a food service establishment.

12. The electronic framework of claim 1, wherein the multiple local platforms include a home system, a paid parking facility and another vehicle.

13. The electronic framework of claim 1, wherein the multiple local platforms include a charging station, a roadside unit, and a tolling unit.

14. A method for establishing an electronic framework for providing personalized assistance to a user in a vehicle having a controller with a processor and tangible, non-transitory memory on which instructions are recorded, the method comprising:
establishing bi-directional communication between a central platform and the controller, the central platform being located remotely relative to the vehicle, the central platform being communicatively coupled to multiple local platforms having respective resources;
adapting the controller to request the central platform for interaction with at least one of the multiple local platforms;
verifying respective credentials of the multiple local platforms, assessing availability of the respective resources and generating a resource access schedule based on availability of the respective resources, via the central platform;
transmitting the resource access schedule to the controller and the multiple local platforms, via the central platform; and
incorporating a common set of application programming interfaces (APIs) in the central platform and the multiple local platforms to enable resource reservation and resource cancellation for the respective resources in the resource access schedule.

15. The method of claim 14, further comprising:
executing an authentication module upon receiving a registration request from at least one of the multiple local platforms, via the central platform;
designating a respective participation level for the multiple local platforms, the respective participation level including first tier access level and a second tier access level, via the central platform; and
providing a status update of the resource access schedule to the controller upon user demand, via the central platform.

16. The method of claim 14, further comprising:
queueing the respective resources based in part on a nature of the respective resources and respective locations on a user route, via the central platform; and
running a priority check when a plurality of the respective resources are requested by the controller, via the central platform.

17. The method of claim 14, wherein the multiple local platforms include a first local platform and a second local platform, further comprising:
transmitting a participation request from the first local platform to the second local platform, via the central platform, when the first local platform submits the participation request to the central platform for engaging with the second local platform;
transmitting an access granted message and one or more negotiated limitations to the first local platform when the participation request is successful, via the central platform; and
submitting an alternative resource recommendation to the first local platform when the participation request is not successful, via the central platform.

18. The method of claim 14, wherein the vehicle includes an infotainment unit, further comprising:
hosting a mobile application with the infotainment unit, the mobile application being operable by the user.

19. The method of claim 14, further comprising:
employing a publish-subscribe messaging protocol for communication between the central platform and the multiple local platforms.

20. A vehicle comprising:
a controller having a processor and tangible, non-transitory memory on which instructions are recorded;
a mobile application adapted to interface with the controller, the mobile application being operable by a user of the vehicle;
wherein the controller is adapted to communicate with a central platform and multiple local platforms, the central platform being located remotely relative to the vehicle, the multiple local platforms having respective resources;
a connectivity module installed in the vehicle and adapted to transmit and receive information from the central platform via wireless communication;
wherein the controller is adapted to request the central platform for interaction with at least one of the multiple local platforms, the central platform being adapted to verify respective credentials of the multiple local platforms, assess availability of the respective resources and generate a resource access schedule based on availability of the respective resources; and
wherein the controller is adapted to receive the resource access schedule from the central platform and the multiple local platforms, the central platform and the multiple local platforms having a common set of application programming interfaces (APIs) enabling resource reservation and resource cancellation for the respective resources in the resource access schedule.
